(19) United States
(12) Patent Application Publication
(10) Pub. No.: US 2021/0072431 A1
(43) Pub. Date: Mar. 11, 2021

(54) LIQUID LENSES WITH CERAMIC INSULATING LAYERS

(71) Applicants: CORNING INCORPORATED, Corning, NY (US); UNIVERSITE CLAUDE BERNARD LYON 1, Villeurbanne (FR); Centre National De La Recherche Scientifique-CNRS, Paris (FR)

(72) Inventors: Bruno Berge, Lyon (FR); Gwenael Bonfante, Saint Jory (FR); Benjamin Burger, Lyon (FR); Stéphanie Chevalliot, Lyon (FR); Mathieu Maillard, Lyon (FR); Bérangère Toury-Pierre, Lyon (FR)

(73) Assignees: CORNING INCORPORATED, Corning, NY (US); UNIVERSITE CLAUDE BERNARD LYON 1, Villeurbanne (FR); Centre National De La Recherche Scientifique-CNRS, Paris (FR)

(21) Appl. No.: 16/771,916

(22) PCT Filed: Dec. 13, 2018
(86) PCT No.: PCT/IB2018/001496

§ 371 Date: Jun. 11, 2020

Related U.S. Application Data
(60) Provisional application No. 62/598,333, filed on Dec. 13, 2017.

(51) Int. Cl. G02B 3/14; G02B 26/00; G02B 1/04

(52) U.S. Cl. CPC G02B 3/14; G02B 1/041; G02B 26/005

(57) ABSTRACT

A liquid lens that includes a first window, a second window, and a cavity disposed between the first window and the second window; a first and second liquid disposed within the cavity, the first and second liquid substantially immiscible with each other and having different refractive indices such that an interface between the first and second liquid defines a variable lens, at least a portion of the first liquid disposed within a first portion of the cavity, the second liquid disposed within a second portion of the cavity; a common electrode in electrical communication with the first liquid; and a driving electrode disposed on a sidewall of the cavity and insulated from the first liquid and the second liquid by an insulating element, wherein the insulating element comprises an insulating outer layer in contact with the liquids, the insulating outer layer comprising a lanthanide series oxide.

### CROSS-REFERENCE TO RELATED APPLICATIONS

This application claims the benefit of priority under 35 U.S.C. § 119 of U.S. Provisional Application No. 62/598,333, filed Dec. 13, 2017, the content of which is incorporated herein by reference in its entirety.

### FIELD OF THE DISCLOSURE

The disclosure relates to liquid lenses and, more particularly, liquid lenses with ceramic insulation layers, such as lanthanide series oxide layers.

### BACKGROUND

Liquid lenses generally include two immiscible liquids disposed within a chamber. Varying an electric field applied to the liquids can vary the wettability of one of the liquids relative to walls of the chamber, which has the effect of varying the shape of a meniscus formed between the two liquids. Further, in various applications, changes to the shape of the meniscus result in changes to the focal length of the lens.

Conventional liquid lens configurations make use of an insulating feature that resides between an electrode and the immiscible liquids. Polymeric materials are commonly employed as the insulation feature, as they can provide electrical insulation and exhibit a desired hydrophobicity with regard to the wetting properties of one of the liquids. Nevertheless, these liquid lens configurations suffer from various drawbacks associated with these polymer layers. For example, the polymer insulating features are in contact with the liquids and, over time, are often susceptible to chemical reactions, leaching or other changes that can significantly alter their insulating and/or hydrophobicity characteristics. As another example, liquid lens configurations that employ polymeric insulation features can suffer from low manufacturing yields as these features typically have low scratch resistance, and scratches can negatively impact the performance characteristics of the liquid lenses in which they reside. These polymeric insulation features are also characterized by relatively low temperature stability, which can limit the applications that can make use of conventional liquid lenses containing these polymeric materials. Still further, conventional liquid lens configurations that employ polymeric insulating features are generally inadequate for DC-driven electro-wetting applications. Finally, many of these polymeric insulating features are UV-sensitive, again limiting the applications that can make use of conventional liquid lenses containing these polymeric materials.

Accordingly, there is a need for liquid lens configurations with insulating features that offer improved chemical, temperature and mechanical stability, which can translate into improved liquid lens reliability, performance and manufacturing cost.

### SUMMARY OF THE DISCLOSURE

According to some aspects of the present disclosure, a liquid lens is provided that includes: a first window, a second window, and a cavity disposed between the first window and the second window; a first liquid and a second liquid disposed within the cavity, the first liquid and the second liquid substantially immiscible with each other and having different refractive indices such that an interface between the first liquid and the second liquid defines a variable lens, at least a portion of the first liquid disposed within a first portion of the cavity, the second liquid disposed within a second portion of the cavity; a common electrode in electrical communication with the first liquid; and a driving electrode disposed on a sidewall of the cavity and insulated from the first liquid and the second liquid by an insulating element. Further, the insulating element comprises an insulating outer layer in contact with the liquids, the insulating outer layer comprising a lanthanide series oxide.

According to other aspects of the present disclosure, a liquid lens is provided that includes: a first window, a second window, and a cavity disposed between the first window and the second window; a first liquid and a second liquid disposed within the cavity, the first liquid and the second liquid substantially immiscible with each other and having different refractive indices such that an interface between the first liquid and the second liquid defines a variable lens, at least a portion of the first liquid disposed within a first portion of the cavity, the second liquid disposed within a second portion of the cavity; a common electrode in electrical communication with the first liquid; and a driving electrode disposed on a sidewall of the cavity and insulated from the first liquid and the second liquid by an insulating element. The insulating element comprises an insulating outer layer in contact with the liquids, the insulating outer layer comprising a lanthanide series oxide. Further, the lens exhibits a contact angle hysteresis of no more than 3° upon a sequential application of a driving voltage to the driving electrode from 0V to a maximum driving voltage, followed by a return to 0V.

According to further aspects of the present disclosure, a liquid lens is provided that includes: a first window, a second window, and a cavity disposed between the first window and the second window; a first liquid and a second liquid disposed within the cavity, the first liquid and the second liquid substantially immiscible with each other and having different refractive indices such that an interface between the first liquid and the second liquid defines a variable lens, at least a portion of the first liquid disposed within a first portion of the cavity, the second liquid disposed within a second portion of the cavity; a common electrode in electrical communication with the first liquid; and a driving electrode disposed on a sidewall of the cavity and insulated from the first liquid and the second liquid by an insulating element. The insulating element comprises an insulating outer layer in contact with the liquids, the insulating outer layer comprising a lanthanide series oxide. Further, the lens exhibits a contact angle hysteresis of no more than 3° upon a sequential application of a driving voltage to the driving electrode from 0V to a maximum driving voltage, followed by a return to 0V. In addition, the sequential application of the driving voltage is conducted after the insulating layer is subjected to a thermal aging protocol comprising contact with deionized water for one week at 85° C.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1A is a schematic cross-sectional view of some embodiments of a liquid lens.

FIG. 1B is a schematic cross-sectional view of some embodiments of a liquid lens.

FIGS. 2A and 2B provide a schematic comparison of electronic interactions and hydrophobic properties of comparative alumina and lanthanide series-based ceramics, according to some embodiments of the disclosure.

FIG. 3 is an electro-wetting curve of a liquid lens configuration with an insulating element having a parylene base layer and a cerium oxide insulating outer layer, according to some embodiments of the disclosure.

FIG. 4 is an optical response to voltage chart of a liquid lens configuration with an insulating element having a parylene base layer and a cerium oxide insulating outer layer, according to some embodiments of the disclosure.

FIG. 5A is a set of electron beam micrographs of the surface of cerium oxide layers produced according to a sol-gel process; and

FIG. 5B is a set of electron beam micrographs of the surface of cerium oxide layers produced according to a physical vapor deposition (PVD) process.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

In various embodiments, a liquid lens is provided that includes a first window, a second window, and a cavity disposed between the first window and the second window. A first and second liquid are disposed within the cavity. The first and second liquids are substantially immiscible with each other and have different refractive indices such that an interface between the first and second liquid defines a variable lens. In some embodiments, at least a portion of the first liquid is disposed within a first portion of the cavity, and the second liquid is disposed within a second portion of the cavity. A common electrode is in electrical communication with the first liquid, and a driving electrode is disposed on a sidewall of the cavity and insulated from the first liquid and the second liquid by an insulating element. Further, the insulating element comprises an insulating outer layer in contact with the liquids that comprises YO₂, where Y is a lanthanide series element.

In embodiments, the voltage differential between the voltage at the common electrode and the voltage at the driving electrode can be adjusted. The voltage differential can be controlled and adjusted to move an interface between the liquids (i.e., a meniscus) to a desired position along the sidewalls of the cavity. By moving the interface along sidewalls of the cavity, it is possible to change the focus (e.g., diopters) and/or tilt of the liquid lens. Further, during operation of the liquid lens, the dielectric and/or surface energy properties of the liquid lens and its constituents can change. For example, the dielectric properties of the liquids and/or insulating elements can change in response to exposure to the voltage differential over time, changes in temperature, and other factors. As another example, the surface energy of the insulating elements can change in response to exposure to the first and second liquids over time. In turn, the changes in the properties of the liquid lens and those of its constituents (e.g., its insulating elements) can degrade the reliability and performance characteristics of the liquid lens.

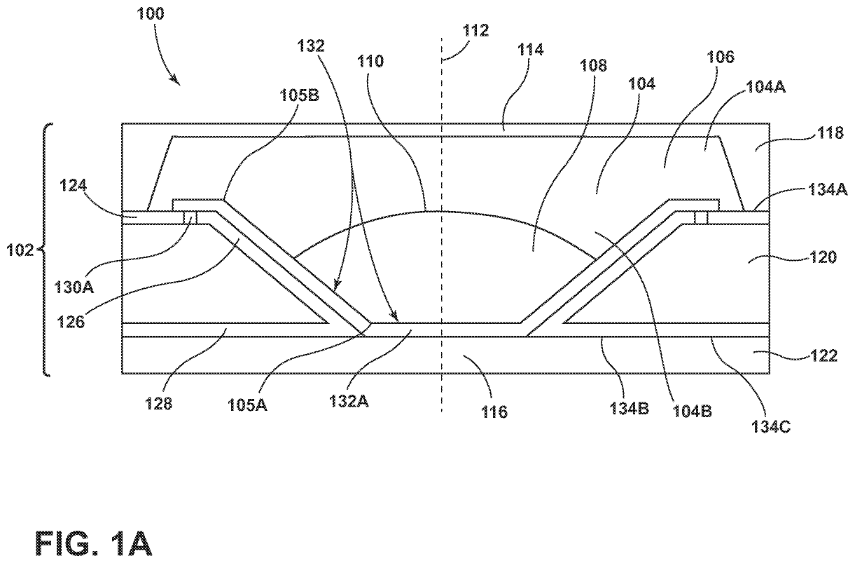

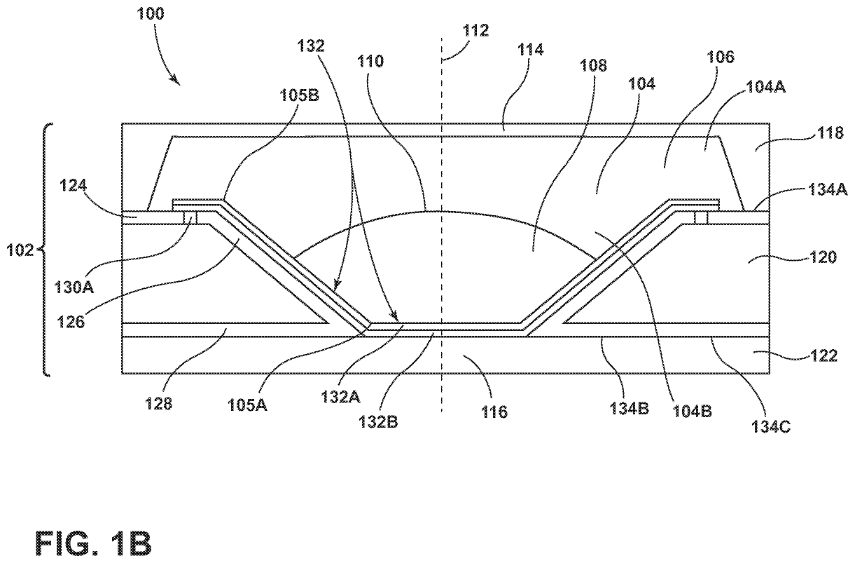

Referring to FIGS. 1A and 1B, cross-sectional views of some embodiments of a liquid lens 100 are provided. In some embodiments, the liquid lens 100 comprises a lens body 102 and a cavity 104 formed in the lens body. A first liquid 106 and a second liquid 108 are disposed within cavity 104. In some embodiments, first liquid 106 is a polar liquid or a conducting liquid. Additionally, or alternatively, second liquid 108 is a non-polar liquid or an insulating liquid. In some embodiments, first liquid 106 and second liquid 108 are immiscible with each other and have different refractive indices such that an interface 110 between the first liquid and the second liquid forms a lens. In some embodiments, first liquid 106 and second liquid 108 have substantially the same density, which can help to avoid changes in the shape of interface 110 as a result of changing the physical orientation of liquid lens 100 (e.g., as a result of gravitational forces).

In some embodiments of the liquid lens 100 depicted in FIGS. 1A and 1B, cavity 104 comprises a first portion, or headspace, 104A and a second portion, or base portion, 104B. For example, second portion 104B of cavity 104 is defined by a bore in an intermediate layer of liquid lens 100 as described herein. Additionally, or alternatively, first portion 104A of cavity 104 is defined by a recess in a first outer layer of liquid lens 100 and/or disposed outside of the bore in the intermediate layer as described herein. In some embodiments, at least a portion of first liquid 106 is disposed in first portion 104A of cavity 104. Additionally, or alternatively, second liquid 108 is disposed within second portion 104B of cavity 104. For example, substantially all or a portion of second liquid 108 is disposed within second portion 104B of cavity 104. In some embodiments, the perimeter of interface 110 (e.g., the edge of the interface in contact with the sidewall of the cavity) is disposed within second portion 104B of cavity 104.

Interface 110 of the liquid lens 100 (see FIGS. 1A and 1B) can be adjusted via electrowetting. For example, a voltage can be applied between first liquid 106 and a surface of cavity 104 (e.g., an electrode positioned near the surface of the cavity and insulated from the first liquid as described herein) to increase or decrease the wettability of the surface of the cavity with respect to the first liquid and change the shape of interface 110. In some embodiments, adjusting interface 110 changes the shape of the interface, which changes the focal length or focus of liquid lens 100. For example, such a change of focal length can enable liquid lens 100 to perform an autofocus function. Additionally, or alternatively, adjusting interface 110 tilts the interface relative to an optical axis 112 of liquid lens 100. For example, such tilting can enable liquid lens 100 to perform an optical image stabilization (OIS) function. Adjusting interface 110 can be achieved without physical movement of liquid lens 100 relative to an image sensor, a fixed lens or lens stack, a housing, or other components of a camera module in which the liquid lens can be incorporated.

In some embodiments, lens body 102 of liquid lens 100 comprises a first window 114 and a second window 116. In some of such embodiments, cavity 104 is disposed between first window 114 and second window 116. In some embodiments, lens body 102 comprises a plurality of layers that cooperatively form the lens body. For example, in the embodiments shown in FIGS. 1A and 1B, lens body 102 comprises a first outer layer 118, an intermediate layer 120, and a second outer layer 122. In some of such embodiments, intermediate layer 120 comprises a bore formed therethrough. First outer layer 118 can be bonded to one side (e.g., the object side) of intermediate layer 120. For example, first outer layer 118 is bonded to intermediate layer 120 at a bond 134A. Bond 134A can be an adhesive bond, a laser bond (e.g., a laser weld), or another suitable bond capable of maintaining first liquid 106 and second liquid 108 within cavity 104. Additionally, or alternatively, second outer layer 122 can be bonded to the other side (e.g., the image side) of intermediate layer 120. For example, second outer layer 122 is bonded to intermediate layer 120 at a bond 134B and/or a bond 134C, each of which can be configured as described herein with respect to bond 134A. In some embodiments, intermediate layer 120 is disposed between first outer layer 118 and second outer layer 122, the bore in the intermediate layer is covered on opposing sides by the first outer layer and the second outer layer, and at least a portion of cavity 104 is defined within the bore. Thus, a portion of first outer layer 118 covering cavity 104 serves as first window 114, and a portion of second outer layer 122 covering the cavity serves as second window 116.

In some embodiments, cavity 104 comprises first portion 104A and second portion 104B. For example, in the embodiments shown in FIGS. 1A and 1B, second portion 104B of cavity 104 is defined by the bore in intermediate layer 120, and first portion 104A of the cavity is disposed between the second portion of the cavity and first window 114. In some embodiments, first outer layer 118 comprises a recess as shown in FIGS. 1A and 1B, and first portion 104A of cavity 104 is disposed within the recess in the first outer layer. Thus, first portion 104A of cavity is disposed outside of the bore in intermediate layer 120.

In some embodiments, cavity 104 (e.g., second portion 104B of the cavity) is tapered as shown in FIGS. 1A and 1B such that a cross-sectional area of the cavity decreases along optical axis 112 in a direction from the object side to the image side. For example, second portion 104B of cavity 104 comprises a narrow end 105A and a wide end 105B. The terms “narrow” and “wide” are relative terms, meaning the narrow end is narrower than the wide end. Such a tapered cavity can help to maintain alignment of interface 110 between first liquid 106 and second liquid 108 along optical axis 112. In other embodiments, the cavity is tapered such that the cross-sectional area of the cavity increases along the optical axis in the direction from the object side to the image side or non-tapered such that the cross-sectional area of the cavity remains substantially constant along the optical axis.

In some embodiments, image light enters the liquid lens 100 depicted in FIGS. 1A and 1B through first window 114, is refracted at interface 110 between first liquid 106 and second liquid 108, and exits the liquid lens through second window 116. In some embodiments, first outer layer 118 and/or second outer layer 122 comprise a sufficient transparency to enable passage of the image light. For example, first outer layer 118 and/or second outer layer 122 comprise a polymeric, glass, ceramic, or glass-ceramic material. In some embodiments, outer surfaces of first outer layer 118 and/or second outer layer 122 are substantially planar. Thus, even though liquid lens 100 can function as a lens (e.g., by refracting image light passing through interface 110), outer surfaces of the liquid lens can be flat as opposed to being curved like the outer surfaces of a fixed lens. In other embodiments, outer surfaces of the first outer layer and/or the second outer layer are curved (e.g., concave or convex). Thus, the liquid lens comprises an integrated fixed lens. In some embodiments, intermediate layer 120 comprises a metallic, polymeric, glass, ceramic, or glass-ceramic material. Because image light can pass through the bore in intermediate layer 120, the intermediate layer may or may not be transparent.

Although lens body 102 of the liquid lens 100 shown in FIGS. 1A and 1B is described as comprising first outer layer 118, intermediate layer 120, and second outer layer 122, other embodiments are included in this disclosure. For example, in some other embodiments, one or more of the layers is omitted. For example, the bore in the intermediate layer can be configured as a blind hole that does not extend entirely through the intermediate layer, and the second outer layer can be omitted. Although first portion 104A of cavity 104 is described herein as being disposed within the recess in first outer layer 118, other embodiments are included in this disclosure. For example, in some other embodiments, the recess is omitted, and the first portion of the cavity is disposed within the bore in the intermediate layer. Thus, the first portion of the cavity is an upper portion of the bore, and the second portion of the cavity is a lower portion of the bore. In some other embodiments, the first portion of the cavity is disposed partially within the bore in the intermediate layer and partially outside the bore.

In some embodiments, liquid lens 100 (see FIGS. 1A and 1B) comprises a common electrode 124 in electrical communication with first liquid 106. Additionally, or alternatively, liquid lens 100 comprises a driving electrode 126 disposed on a sidewall of cavity 104 and insulated from first liquid 106 and second liquid 108. Different voltages can be supplied to common electrode 124 and driving electrode 126 to change the shape of interface 110 as described herein.

In some embodiments, liquid lens 100 (see FIGS. 1A and 1B) comprises a conductive layer 128 at least a portion of which is disposed within cavity 104. For example, conductive layer 128 comprises a conductive coating applied to intermediate layer 120 prior to bonding first outer layer 118 and/or second outer layer 122 to the intermediate layer. Conductive layer 128 can comprise a metallic material, a conductive polymer material, another suitable conductive material, or a combination thereof. Additionally, or alternatively, conductive layer 128 can comprise a single layer or a plurality of layers, some or all of which can be conductive. In some embodiments, conductive layer 128 defines common electrode 124 and/or driving electrode 126. For example, conductive layer 128 can be applied to substantially the entire outer surface of intermediate layer 118 prior to bonding first outer layer 118 and/or second outer layer 122 to the intermediate layer. Following application of conductive layer 128 to intermediate layer 118, the conductive layer can be segmented into various conductive elements (e.g., common electrode 124, driving electrode 126, and/or reference electrodes as described herein). In some embodiments, liquid lens 100 comprises a scribe 130A in conductive layer 128 to isolate (e.g., electrically isolate) common electrode 124 and driving electrode 126 from each other. In some embodiments, scribe 130A comprises a gap in conductive layer 128. For example, scribe 130A is a gap with a width of about 5 μm, about 10 μm, about 15 μm, about 20 μm, about 25 μm, about 30 μm, about 35 μm, about 40 μm, about 45 μm, about 50 μm, or any ranges defined by the listed values.

As also depicted in FIGS. 1A and 1B, the liquid lens 100 comprises an insulating element 132 disposed within cavity 104. For example, insulating element 132 comprises an insulating coating applied to intermediate layer 120 prior to bonding first outer layer 118 and/or second outer layer 122 to the intermediate layer. In some embodiments, insulating element 132 comprises an insulating coating applied to conductive layer 128 and second window 116 after bonding second outer layer 122 to intermediate layer 120 and prior to bonding first outer layer 118 to the intermediate layer. Thus, the insulating element 132 covers at least a portion of conductive layer 128 within cavity 104 and second window 116. In some embodiments, insulating element 132 can be sufficiently transparent to enable passage of image light through second window 116 as described herein.

In some embodiments of the liquid lenses 100 depicted in FIGS. 1A and 1B, the insulating element 132 covers at least a portion of driving electrode 126 (e.g., the portion of the driving electrode disposed within cavity 104) to insulate first liquid 106 and second liquid 108 from the driving electrode. Additionally, or alternatively, at least a portion of common electrode 124 disposed within cavity 104 is uncovered by insulating element 132. Thus, common electrode 124 can be in electrical communication with first liquid 106 as described herein. In some embodiments, insulating element 132 comprises a hydrophobic surface layer of second portion 104B of cavity 104. Such a hydrophobic surface layer can help to maintain second liquid 108 within second portion 104B of cavity 104 (e.g., by attraction between the non-polar second liquid and the hydrophobic material) and/or enable the perimeter of interface 110 to move along the hydrophobic surface layer (e.g., by electrowetting) to change the shape of the interface as described herein. Further, the liquid lens 100 shown in FIGS. 1A and 1B, based at least in part on the insulating element 132, can exhibit a contact angle hysteresis (i.e., at the interface 110 between the liquids 106, 108) of no more than 3°. As used herein, the “contact angle hysteresis” refers to the differential in measured contact angles of the second liquid 108 with the insulating element 132 upon a sequential application of a driving voltage to the driving electrode 126 (e.g., the differential between the driving voltage supplied to the driving electrode and the common voltage supplied to the common electrode) from 0V to a maximum driving voltage, followed by a return to 0V (i.e., as relative to the common electrode 124). The initial contact angle without voltage is a maximum of 25° and increases to the contact angle due to the electrowetting effect is at least 15° at “the maximum driving voltage”, as used herein. For example, the maximum driving voltage can be 10V, 20V, 30V, 40V, 50V, 60V, or 70V.

Referring now to FIG. 1A, embodiments of the liquid lens 100 are configured such that the driving electrode 126 is disposed on a sidewall of the cavity 104 and insulated from the first liquid 106 and the second liquid 108 by an insulating element 132. The insulating element 132 includes an insulating outer layer 132A, as shown, that is in contact with the first and second liquids 106, 108. Further, insulating outer layer 132A comprises a lanthanide series oxide. As used herein, a “lanthanide series oxide” includes YO₂, Y₂O₃, (Y=Pr)₆O₁₁, (Y=Tb)₄O₇, or combinations thereof, where Y is a lanthanide series element. Example lanthanide series elements include La, Ce, Pr, Nd, Pm, Sm, Eu, Gd, Tb, Dy, Ho, Er, Tm, Yb and Lu. In a preferred embodiment of the liquid lens 100, insulating outer layer 132A comprises YO₂, where Y is Ce, such that YO₂ is CeO₂. Employing CeO₂ in the insulating outer layer 132A is advantageous in part because cerium is more abundant and less costly than other lanthanide series elements. Further, in the implementation of liquid lens 100 depicted in FIG. 1A, the insulating element 132 is monolithic in the sense that insulating outer layer 132A serves the dual function of being electrically insulating with regard to the liquids 106, 108 and the driving electrode 126, and hydrophobic with regard to the first liquid 106. The liquid lens 100 depicted in FIG. 1A, given its reliance on one monolithic insulating outer layer 132A, can be advantageous from a processing and/or manufacturing standpoint over other more complex configurations of the insulating element 132 (e.g., those that rely on a plurality of layers, such as described below in connection with FIG. 1B).

In embodiments of the liquid lens 100 depicted in FIG. 1A, the thickness of the insulating outer layer 132A of the insulating element 132 is from about 0.5 microns to about 10 microns, from about 1 micron to about 10 microns, from about 1 micron to about 9 microns, from about 1 micron to about 8 microns, from about 1 micron to about 7 microns, from about 1 micron to about 6 microns, from about 1 micron to about 5 microns, from about 1 micron to about 4 microns, from about 1 micron to about 3 microns, from about 1 micron to about 2 microns, and all values between these thickness endpoints. For example, in some embodiments, the thickness of the insulating outer layer 132A of the liquid lens 100 depicted in FIG. 1A is from about 0.5 microns to about 2 microns.

Referring now to FIG. 1B, embodiments of the liquid lens 100 are configured such that the driving electrode 126 is disposed on a sidewall of the cavity 104 and insulated from the first liquid 106 and the second liquid 108 by an insulating element 132. As shown in FIG. 1B, the insulating element 132 includes an insulating outer layer 132A that is in contact with the first and second liquids 106, 108, and a base layer 132B between the insulating outer layer 132A and the driving electrode 126. Further, insulating outer layer 132A comprises a lanthanide series oxide. For example, in some embodiments of the liquid lens 100 shown in FIG. 1B, insulating outer layer 132A comprises YO₂, where Y is Ce, such that YO₂ is CeO₂. As for the base layer 132B, it can comprise a polymeric or non-polymeric insulating material. For example, the base layer 132B can include one or more of polytetrafluoroethylene (PTFE), parylene, porous organosilicate films comprising silsesquioxane, polyimide, fluorinated polyimide, SILK® semiconductor dielectric resin (from Dow Chemical Company), fluorine-doped silicon oxides, fluorinated amorphous carbon thin films, silicone polymers, amorphous fluoropolymers (e.g., Teflon® from DuPont), poly(arylene ethers), fluorinated and non-fluorinated para-xylylene linear polymers (e.g., Parylene C), amorphous fluoropolymers (e.g., Cytop® from Asahi Glass Co.), Hyflon® (from Solvay), aromatic vinyl siloxane polymers (e.g., DVS-BCD from Dow Chemical), diamond-like carbon, polyethylene, polypropylene, fluoroethylene propylene polymer, polynaphthalene, silocone-like polymeric films (SiOₓC_{y}H_{z}), SiO₂, Si₃N₄, BaTiO₃, HfO₂, HfSiO₄, ZrO₂, Ta₂O₅, TiO₂, BarSrTiO₃, SrTiO₃, Al₂O₃, La₂O₃, Y₂O₃, insulating sol-gels (e.g., silicon alkoxides), and spin-on-glass (e.g., Accuglass® Honeywell, Inc.). In a preferred implementation, the base layer 132B includes a parylene material (e.g., Parylene C).

As noted earlier, employing CeO₂ in the insulating outer layer 132A is advantageous in part because cerium is more abundant and less costly than other lanthanide series elements. In the implementation of liquid lens 100 depicted in FIG. 1B, the insulating element 132 is a multi-layer stack given that includes an insulating outer layer 132A and a base layer 132B. Here, the base layer 132B and insulating outer layer 132A are electrically insulating with regard to the liquids 106, 108 and the driving electrode. In addition, the insulating outer layer 132A is also hydrophobic with regard to the first liquid 106. The liquid lens 100 depicted in FIG. 1B, given its reliance on an insulating element 132 in the form of a multi-layer stack, can offer a performance and/or manufacturing advantage over other configurations of the insulating element 132 (e.g., those that rely on a monolithic insulating outer layer 132A, such as described above in connection with FIG. 1B).

In embodiments of the liquid lens 100 depicted in FIG. 1B, the thickness of the insulating outer layer 132A of the insulating element 132 is from about 0.01 microns to about 2 microns, from about 0.01 micron to about 1.5 microns, from about 0.01 micron to about 1 micron, from about 0.05 microns to about 2 microns, from about 0.05 microns to about 1 micron, from about 0.05 microns to about 0.5 microns, 0.05 microns to about 0.4 microns, from about 0.1 microns to about 2 microns, from about 0.1 microns to about 1.5 microns, from about 0.1 microns to about 1 micron, from about 0.1 microns to about 0.5 microns, and all values between these thickness endpoints. For example, in some embodiments, the thickness of the insulating outer layer 132A of the liquid lens 100 depicted in FIG. 1B is from about 0.05 microns to about 0.4 microns. As for the base layer 132B, it can have a thickness that ranges from about 0.5 microns to about 10 microns, from about 1 micron to about 10 microns, from about 1 micron to about 9 microns, from about 1 micron to about 8 microns, from about 1 micron to about 7 microns, from about 1 micron to about 6 microns, from about 1 micron to about 5 microns, from about 1 micron to about 4 microns, from about 1 micron to about 3 microns, from about 1 micron to about 2 microns, and all values between these thickness endpoints. For example, in some embodiments, the thickness of the insulating outer layer 132B of the liquid lens 100 depicted in FIG. 1B is from about 1 micron to about 10 microns.

Further, implementations of the liquid lens 100 depicted in FIG. 1B comprises an insulating element 132 (e.g., as including insulating outer layer 132A and base layer 132B) having a total thickness that ranges from about 0.5 microns to about 10 microns, 0.5 microns to about 5 microns, from about 0.5 microns to about 2.5 microns, and all values between these thickness endpoints.

Owing to the unexpected combination of hydrophobicity and insulating properties of the insulating outer layer 132A of the insulating element 132, the liquid lenses 100 depicted in FIGS. 1A and 1B offer several advantages over conventional liquid lens configurations. Among these advantages, it is believed that the lanthanide series oxide ceramic composition of the outer layer 132A provides improved temperature stability (e.g., as compared to polymeric hydrophobic layers) for the lenses 100. It is also believed that the lanthanide series oxide ceramic composition of the outer layer 132A provides improved chemical stability (e.g., as compared to polymeric hydrophobic layers) for the lenses, e.g., as judged after a thermal aging treatment. In such a treatment, the liquid lens 100 exhibits a contact angle hysteresis (i.e., at the interface 110 between the liquids 106, 108) of no more than 3° upon a sequential application of a driving voltage to the driving electrode 126 from 0V to the maximum driving voltage, followed by a return to 0V (i.e., as relative to the common electrode 124), wherein the sequential application of the driving voltage is conducted after the insulating layer 132A is subjected to a thermal aging protocol comprising contact with deionized water for one week at 85° C. Still further, it is also believed that the lanthanide series oxide ceramic composition of the outer layer 132A ensures that this layer has electrical characteristics that allow the liquid lens 100 to be employed in a DC-based electrowetting application. In addition, it is also believed that the lanthanide series oxide ceramic composition of the outer layer 132A provides superior scratch and UV resistance as compared to comparative outer polymeric hydrophobic layers of an insulating feature in contact with the liquids, e.g., liquid 106, 108.

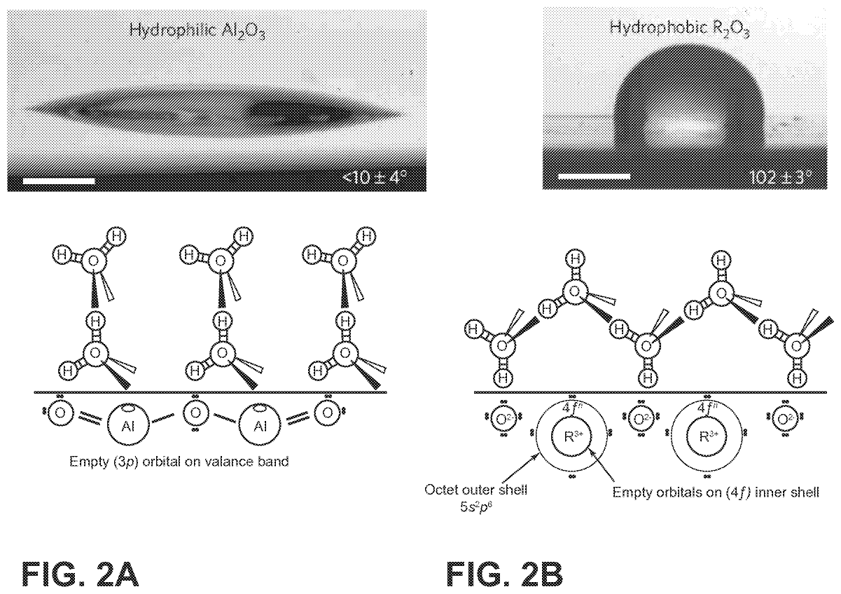

Referring now to FIGS. 2A and 2B, a schematic comparison is provided of electronic interactions and hydrophobic properties of comparative alumina (Al₂O₃) and lanthanide series-based oxide ceramics, such as employed in the insulating outer layer 132A of the liquid lenses 100 depicted in FIGS. 1A and 1B, according to some embodiments of the disclosure. As shown in FIG. 2A, the 3p orbitals are empty of electrons for Al₂O₃, contributing to its hydrophilicity, which makes it unsuitable for use in as an insulating outer layer 132A. In contrast, without being by theory, it is believed that the electron-filled outer orbital, 5s²p⁶, of the lanthanide series oxide (Y₂O₃), where Y is a lanthanide series element, contributes to its hydrophobicity and advantageous use as in a composition employed in the insulating outer layer 132A.

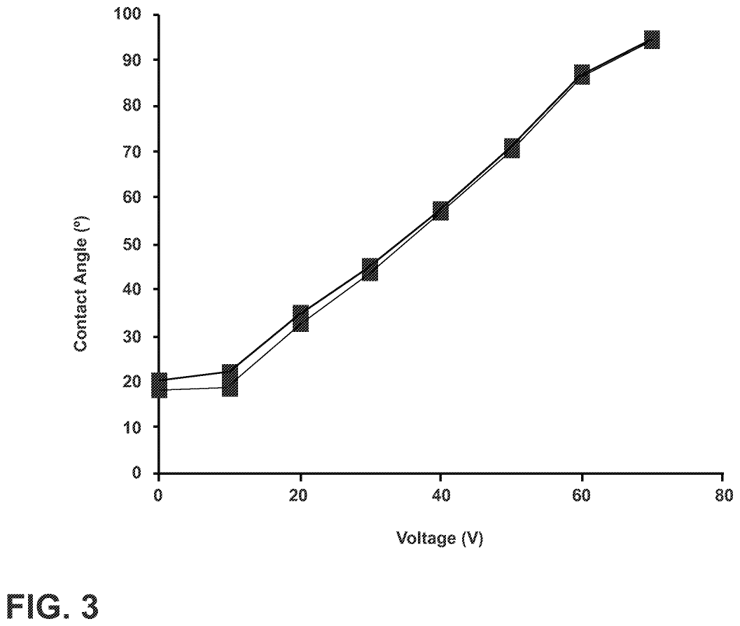

Referring now to FIG. 3, an electro-wetting curve of a liquid lens configuration (e.g., as comparable to the liquid lens 100 configuration of FIG. 1B) is provided with an insulating element having a parylene C base layer having a thickness of about 5 microns and a cerium oxide insulating outer layer having a thickness of about 0.5 microns, according to some embodiments of the disclosure. More particularly, the curve in FIG. 3 was generated by preparing a prototype liquid lens configuration with a first liquid of an aqueous solution of calcium chloride and a second liquid of bromododecane. An initial contact angle of about 20° was measured at a driving voltage of 0V and a maximum contact angle of about 95° was measured at a driving voltage of 70V. Upon return to 0V, a hysteresis of less than 3° was observed.

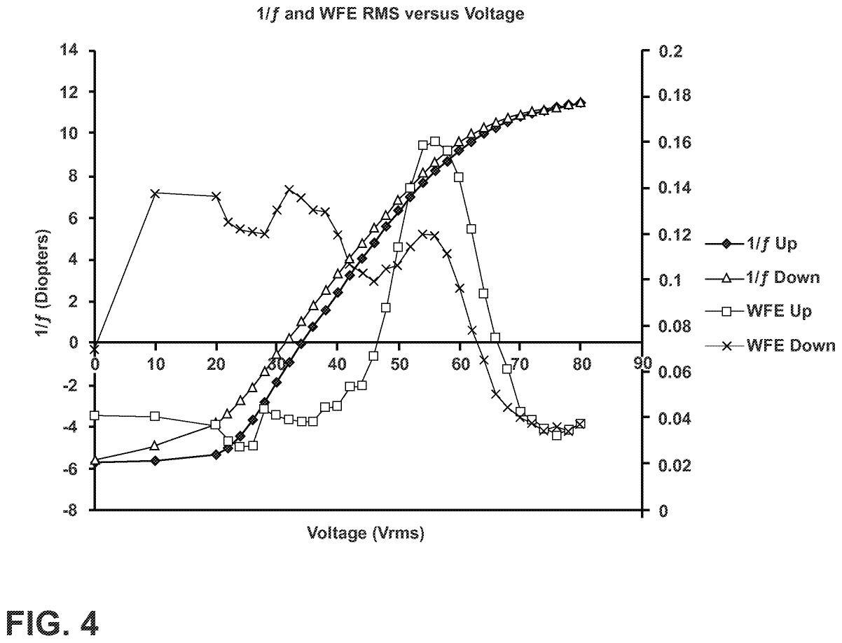

Now referring to FIG. 4, an optical response to voltage chart is provided of a liquid lens configuration (e.g., as comparable to the liquid lens 100 configuration of FIG. 1B) with an insulating element having a parylene C base layer having a thickness of 5 microns and a cerium oxide insulating outer layer having a thickness of 0.5 microns, according to some embodiments of the disclosure. More particularly, the curve in FIG. 4 was generated by preparing a prototype liquid lens configuration with a first liquid of an aqueous solution of calcium chloride and a second liquid of bromododecane. An initial contact angle of about 20° was measured at a driving voltage of 0V and a maximum contact angle of about 95° was measured at a driving voltage of 70V. As is evident from FIG. 4, this liquid lens configuration demonstrates a maximum hysteresis of about 1.3 diopters (D) within the diopter range of −2 D to +10 D.

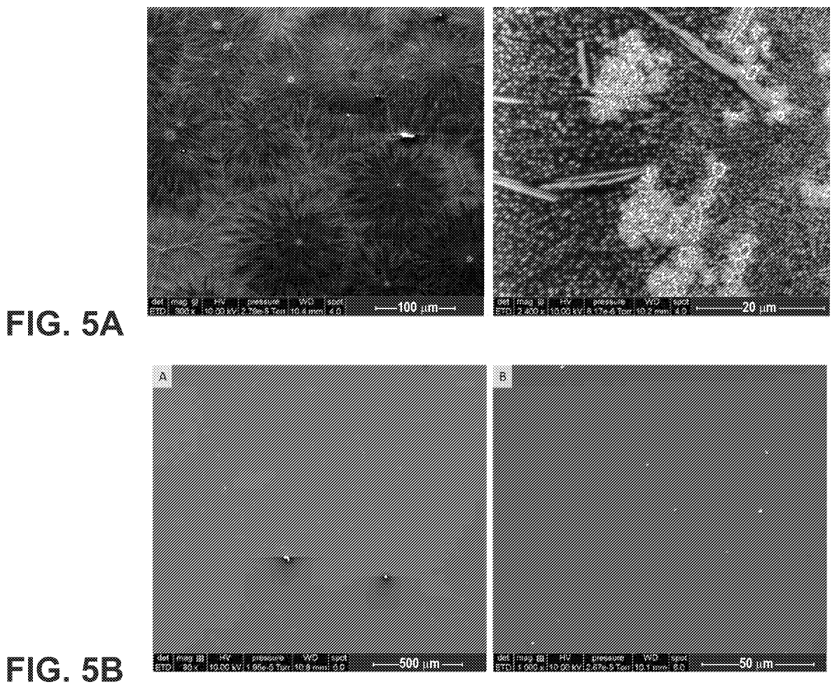

Referring now to FIGS. 5A and 5B, a set of electron beam micrographs is provided of the surface of cerium oxide layers produced according to a sol-gel process (FIG. 5A) and a set of electron beam micrographs of the surface of cerium oxide layers (e.g., as suitable for use as an insulating outer layer 132A) produced according to a physical vapor deposition (PVD) process (FIG. 5B). As is evident from these figures, the surface roughness (e.g., Ra surface roughness determined as described in ISO 25178, Geometric Product Specifications (GPS)—Surface texture: areal) of the cerium oxide layers produced with a PVD process is significantly lower (i.e., with features having an average maximum height of less than 10 microns) than the surface roughness of the cerium oxide layers produced with a sol-gel process. As such, processing history of the cerium oxide layers can significantly influence the surface roughness of these layers. Further, it has been observed through electrowetting studies of these samples that the cerium oxide layers produced by a sol-gel process do not exhibit the required hydrophobicity suitable for the liquid lenses 100 (see FIGS. 1A and 1B) of the disclosure. In contrast, the cerium oxide layers produced by a PVD process do exhibit the required hydrophobicity suitable for the liquid lenses 100 (see FIGS. 1A and 1B) of the disclosure.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A liquid lens, comprising:
a first window, a second window, and a cavity disposed between the first window and the second window;
a first liquid and a second liquid disposed within the cavity, the first liquid and the second liquid substantially immiscible with each other and having different refractive indices such that an interface between the first liquid and the second liquid defines a variable lens;
a common electrode in electrical communication with the first liquid; and
a driving electrode disposed on a sidewall of the cavity and insulated from the first liquid and the second liquid by an insulating element,
wherein the insulating element comprises an insulating outer layer in contact with the liquids, the insulating outer layer comprising a lanthanide series oxide.

2. The lens according to claim 1, wherein the insulating outer layer comprises CeO₂.

3. The lens according to claim 1, wherein the insulating element further comprises a base layer between the insulating outer layer and the driving electrode.

4. The lens according to claim 3, wherein the base layer has a thickness from about 1 microns to 10 microns and the insulating outer layer has a thickness from about 0.05 microns to about 0.4 microns.

5. The lens according to claim 3, wherein the base layer comprises a parylene material.

6. The lens according to claim 1, wherein the insulating outer layer is characterized by a surface roughness indicative of a physical vapor deposition process having features with an average maximum height of less than 10 microns.

7. A liquid lens, comprising:
a first window, a second window, and a cavity disposed between the first window and the second window;
a first liquid and a second liquid disposed within the cavity, the first liquid and the second liquid substantially immiscible with each other and having different refractive indices such that an interface between the first liquid and the second liquid defines a variable lens;
a common electrode in electrical communication with the first liquid; and
a driving electrode disposed on a sidewall of the cavity and insulated from the first liquid and the second liquid by an insulating element,
wherein the insulating element comprises an insulating outer layer in contact with the liquids, the insulating outer layer comprising a lanthanide series oxide, and
further wherein the lens exhibits a contact angle hysteresis of no more than 3° upon a sequential application of a driving voltage to the driving electrode from 0V to a maximum driving voltage, followed by a return to 0V.

8. The lens according to claim 7, wherein the insulating outer layer comprises CeO₂.

9. The lens according to claim 7, wherein the insulating element further comprises a base layer between the insulating outer layer and the driving electrode.

10. The lens according to claim 9, wherein the base layer has a thickness from about 1 microns to 10 microns and the insulating outer layer has a thickness from about 0.05 microns to about 0.4 microns.

11. The lens according to claim 9, wherein the base layer comprises a parylene material.

12. The lens according to claim 7, wherein the insulating outer layer is characterized by a surface roughness indicative of a physical vapor deposition process having features with an average maximum height of less than 10 microns.

13. A liquid lens, comprising:
a first window, a second window, and a cavity disposed between the first window and the second window;
a first liquid and a second liquid disposed within the cavity, the first liquid and the second liquid substantially immiscible with each other and having different refractive indices such that an interface between the first liquid and the second liquid defines a variable lens;
a common electrode in electrical communication with the first liquid; and
a driving electrode disposed on a sidewall of the cavity and insulated from the first liquid and the second liquid by an insulating element,
wherein the insulating element comprises an insulating outer layer in contact with the liquids, the insulating outer layer comprising a lanthanide series oxide,
wherein the lens exhibits a contact angle hysteresis of no more than 3° upon a sequential application of a driving voltage to the driving electrode from 0V to a maximum driving voltage, followed by a return to 0V, and
wherein the sequential application of the driving voltage is conducted after the insulating layer is subjected to a thermal aging protocol comprising contact with deionized water for one week at 85° C.

14. The lens according to claim 13, wherein the insulating outer layer comprises CeO₂.

15. The lens according to claim 13, wherein the insulating element further comprises a base layer between the insulating outer layer and the driving electrode.

16. The lens according to claim 15, wherein the base layer has a thickness from about 1 microns to 10 microns and the insulating outer layer has a thickness from about 0.05 microns to about 0.4 microns.

17. The lens according to claim 15, wherein the base layer comprises a parylene material.

18. The lens according to claim 13, wherein the insulating outer layer is characterized by a surface roughness indicative of a physical vapor deposition process having features with an average maximum height of less than 10 microns.
